(19) United States
(12) Patent Application Publication
(10) Pub. No.: US 2020/0088239 A1
(43) Pub. Date: Mar. 19, 2020

(54) PINION FOR TRANSMISSION OF MOVEMENT

(71) Applicant: PSA Automobiles SA, Poissy (FR)

(72) Inventor: Jeremie FISCHER, Suresnes (FR)

(21) Appl. No.: 16/466,956

(22) PCT Filed: Nov. 13, 2017
(86) PCT No.: PCT/FR2017/053079

§ 371 Date: Jun. 5, 2019

(30) Foreign Application Priority Data
Dec. 12, 2016 (FR) 1662288

(51) Int. Cl. F16D 1/076

(52) U.S. Cl. CPC F16D 1/076; F16D 2069/004

(57) ABSTRACT

The invention relates to a pinion (2, 3) for transmitting movement about an axis of rotation (Z), laterally defined by two faces, characterised in that each of the two faces comprises a bearing surface (2a, 2b, 3a, 3b), said bearing surfaces (2a, 2b, 3a, 3b) comprising the same raised motif, the raised motif being such that the superposition of said motif and the specular image thereof only gives one point of intersection or more, irrespective of the angular position of superposition of the specular image in relation to the motif.

### CROSS-REFERENCE TO RELATED APPLICATIONS

This application is the US National Stage under 35 USC § 371 of International Application No. PCT/FR2017/053079, filed 13 Nov. 2017 which claims priority to French Application No. 1662288 filed 12 Dec. 2016, both of which are incorporated herein by reference.

### BACKGROUND

The present invention relates to the holding of two machine components together by friction, without relative movement of the two components, for the transmission of torque.

U.S. Pat. No. 7,472,467 discloses an assembly gripped between the end of a crankshaft, two pinions and a pulley. In this assembly, the crankshaft end front surface, treated by laser structuring, has a projecting relief. This crankshaft end front surface comes into contact with a first front surface, not treated by laser structuring, of the first pinion. The second front face of the first pinion, treated by laser structuring, has a projecting relief and comes into contact with a first front face, not treated by laser structuring, of the second pinion. Lastly, the second front face of the second pinion, treated by laser structuring, comes into contact with a front surface, not treated by laser structuring, of the pulley.

Such an assembly has the drawback of having to process the crankshaft as well as the two pinions. Another drawback is that such processing of the pinions on just one face gives rise to a variety of parts, which is undesirable in production. Another drawback is that the direction of assembly of the pinions must be taken into account.

Consequently, the problem that lies at the heart of the invention is to obtain an assembly between a crankshaft and two pinions having the capacity to transmit torque without rotation between the parts, while limiting the variety of parts and processing of parts and facilitating determination of the direction of assembly.

### SUMMARY

In order to achieve this aim, the a pinion is disclosed for transmitting movement about an axis of rotation, this mechanical component being laterally defined by two faces, wherein each of the two faces comprises a bearing surface, these bearing surfaces comprising the same raised motif, the raised motif being such that the superposition of the motif and the specular (or mirror) image thereof only gives one point of intersection at most, irrespective of the angular position of superposition of the specular image in relation to the motif.

The technical effect is to avoid a partial or total linear superposition of the motifs, which could hinder tightening and create a risk of slipping during operation. The fact that the motif is identical on each face limits the variety of parts and manufacturing operations.

Various additional characteristics can be envisaged, alone or in combination:

As a variation, in order to encourage mechanical grip, the motif is arranged at least near the edge of the bearing surface radially furthest away from the center of rotation.

As a variation, in order to simplify manufacture, the motif comprises the repetition of an elementary motif.

As a variation, so as to offer only the possibility of having motif intersections, the elementary motif has the shape of an arc or a line segment, the extension of which does not pass through the axis of rotation.

As a variation, the raised motif is made by micromachining.

As a variation, the raised motif is preferably made by laser micromachining.

The invention also relates to a mechanical assembly for the transmission of movement about an axis of rotation, comprising a first mechanical component, a second mechanical component, a third component, and a fourth component, the components being juxtaposed along an axis of rotation. The second and third components are gripped between the first and fourth components by tightening means so that the components are rotationally fixed relative to one another about the axis of rotation, each component being in contact with its neighboring component through a contact surface, wherein the second and third components are each a pinion as described above.

As a variation, to simplify assembly, the second and third mechanical components are arranged so that neither has a direction of assembly or so that they are identical.

The invention also relates to a combustion engine comprising a mechanical assembly according to one of the variations described.

According to one embodiment, the first component is a crankshaft.

According to one embodiment, the fourth component is a pulley.

The invention also relates to a vehicle containing such a combustion engine.

### DESCRIPTION OF THE FIGURES

Further features and advantages will emerge from the following description of a particular non-limiting embodiment of the invention, made with reference to the Figures, in which:

FIG. 1 is a schematic representation of an axial assembly including a crankshaft end, two pinions, and a pulley;

FIG. 2 is a schematic representation of two pinions shown facing one another;

FIG. 3 is a schematic representation of the result of superposition of a motif and of the mirror image thereof.

### DETAILED DESCRIPTION

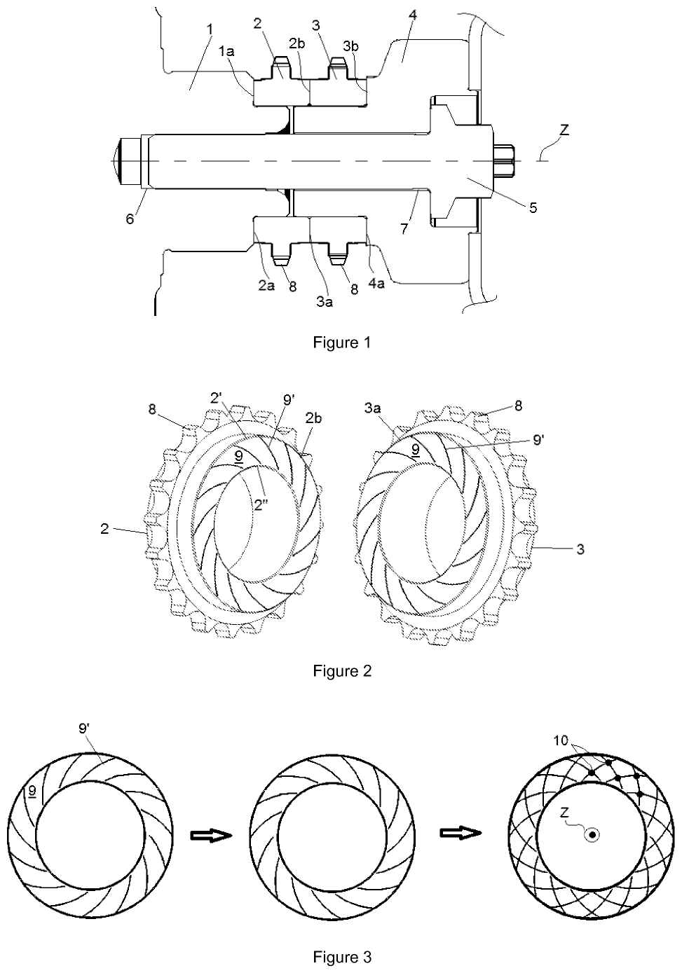

FIG. 1 shows a mechanical assembly with four juxtaposed mechanical components gripped together. In the embodiment, this mechanical assembly comprises as the first mechanical component a crankshaft 1, two pinions 2 and 3 as the second and third mechanical components, and a pulley 4 as the fourth mechanical component.

The components of this mechanical assembly are here intended to be driven together in rotation about a longitudinal axis Z, without any relative rotational movement of these different components in relation to one another about the longitudinal axis Z. That is, they are rotationally fixed relative to each other.

The two pinions 2 and 3 are gripped between the crankshaft 1 and the pulley 2 by means for tightening the pulley 2 against the crankshaft 1, this tightening means preventing the relative rotation of these components in relation to one another about the longitudinal axis Z. Here, the tightening means is in the form of an axial screw 5 mounted along the longitudinal axis Z screwed into a thread 6 in the crankshaft through a passage 7 in the pulley 4.

Each pinion 2 and 3 has the shape of a wheel with an axis of rotation Z, comprising a central orifice, laterally defined by two faces and by teeth 8 around its circular periphery. Thus, in the mechanical assembly, the pinion 2 has one face facing the crankshaft 1 and its second face facing the pinion 3 whereas the pinion 3 has one face facing the pulley 4 and its second face facing the pinion 2.

Each of the faces of the pinions 2, 3 comprises a bearing surface 2a, 2b, 3a, 3b respectively.

When these four components are tightened together, the contact surface 1a of the crankshaft 1 provided for this purpose comes into contact with the bearing surface 2a present on the first lateral face of the pinion 2, the bearing surface 2b comes into contact with the bearing surface 3a of the pinion 3, and the bearing surface 3b comes into contact with a contact surface 4a of the pulley provided for this purpose.

The pinions 2 and 3 are locked in position solely by tightening. Also, as shown in FIG. 2, in order to improve the friction between the contact surfaces of this mechanical assembly, micromachining is performed on each of the bearing surfaces 2a, 2b, 3a, 3b of the pinions 2 and 3 with the same raised motif 9 on the bearing surface. Motif means the whole design created on the bearing surface.

The pinion 2 can be a pinion to transmit power to a distribution system of an engine, while the pinion 3 can be a pinion to transmit power to an oil pump.

The fact of making the same motif simplifies production. Moreover, when two identical pinions 2, 3 are used, as in this embodiment, there is no constraint as regards the direction of assembly, and the variety of components is reduced.

The two pinions 2, 3 can differ from one another but preferably each pinion is arranged so as not to have a direction of assembly. In other words, the pinion 2 can, for example, be fitted the other way around. For example, the two pinions 2, 3 can be of different widths.

This motif can be the repetition of an elementary motif 9, which makes production even easier. As is shown, for example, in FIG. 3, the elementary motif 9′ can have the shape of an arc. The elementary motif 9′ can, however, have another shape, such as a line segment, the extension of which does not pass through the axis of rotation Z of the pinion.

Returning to FIG. 2, the motif 9 is comprised of elementary motifs 9′ that extend from the edge 2′ furthest from the axis of rotation Z to the edge 2″ closest to the axis of rotation. For reasons of torque resistance, it is envisaged that the motif 9 is arranged on the bearing surface at least near the edge 2′ of the bearing surface radially furthest away from the center of rotation Z.

For reasons of ease of implementation, micromachining of the raised motif 9 can be made by laser structuring. Another form of micromachining can be adopted, by electron beam for example. These micromachining operations generate slight surface elevations locally that enable better grip of the bearing surfaces.

In order not to interfere with the tightening of the mechanical assembly, two surfaces and their raised motifs must not be placed face-to-face as this would present two relief heights to be compressed on tightening and create the risk of slipping during operation because the rest of the two surfaces might not be in contact.

In order to avoid this risk, the motif 9 is chosen so that the superposition of the motif 9 and the mirror image thereof (specular image), gives only one point of intersection or more, irrespective of the angular position of the superposition of the specular image in relation to the motif.

As an illustration, in FIG. 3, the diagram on the left shows a front view of the bearing surface of the pinion 2 or 3 and its motif 9. The middle diagram is the image of the bearing surface and the mirror image of the motif 9. The diagram on the right showing the superposition of the first two diagrams one upon the other shows only the points of intersection 10 of the original motif and its superposed image. This is the case, whatever the angular position of superposition of the specular image in relation to the motif 9, otherwise, if the superposed image of the motif were turned about the axis of rotation Z, you would never get the superposition of the original motif and its image other than the points of intersection.

The invention is not limited to the embodiments described. In the embodiment previously described, the pinions 2, 3 constitute circular mechanical components for the transmission of movement about the axis of rotation Z. Other circular mechanical components for the transmission of movement about the axis of rotation can be envisaged, such as pulleys.

Such a mechanical assembly can be present in a combustion engine. Such a combustion engine can be fitted in a motor vehicle.

1. A pinion for transmitting movement about an axis of rotation, laterally defined by two opposed faces, wherein each of the two faces comprises a bearing surface having thereon a raised motif, the raised motif of the each bearing surface being the same and being such that the superposition of this raised motif and the specular image thereof only gives one point of intersection at most, irrespective of the angular position of superposition of the specular image of the raised motif in relation to the raised motif.

2. The pinion according to claim 1, wherein the motif is arranged at least near an edge of the bearing surface radially furthest away from the center of rotation of the pinion.

3. The pinion according to claim 1, wherein the motif comprises the repetition of an elementary motif.

4. The pinion according to claim 3, wherein the elementary motif has the shape of an arc or a line segment, the extension of which does not pass through the axis of rotation of the pinion.

5. The pinion according to claim 1, wherein the raised motif is made by micromachining.

6. The pinion according to claim 5, wherein laser micromachining is used.

7. A mechanical assembly for the transmission of movement about an axis of rotation, comprising a first mechanical component, a second mechanical component, a third component and a fourth component, the components being juxtaposed along the axis of rotation, the second and third components being gripped between the first and fourth components by tightening means so that each component is rotationally fixed relative to one another about the axis of rotation, each component being in contact with its neighboring component through a contact surface, wherein the second and third components are each a pinion according to claim 1.

8. The mechanical assembly according to claim 7, wherein the second and third mechanical components are arranged so that neither has a direction of assembly or are identical.

9. A combustion engine comprising a mechanical assembly according to claim 7.

10. The combustion engine according to claim 9, wherein the first component is a crankshaft.

11. The combustion engine according to claim 9, wherein the fourth component is a pulley.

12. A vehicle comprising a combustion engine according to claim 9.
